(19) United States
(12) Patent Application Publication
(10) Pub. No.: US 2026/0051300 A1
(43) Pub. Date: Feb. 19, 2026

(54) LIQUID CRYSTAL DISPLAY DEVICE

(71) Applicant: Sharp Display Technology Corporation, Kameyama City (JP)

(72) Inventors: Shunsuke NOICHI, Kameyama City (JP); Noriyuki TANAKA, Kameyama City (JP); Tatsuhiko SUYAMA, Kameyama City (JP)

(21) Appl. No.: 19/254,212

(22) Filed: Jun. 30, 2025

(30) Foreign Application Priority Data
Aug. 16, 2024 (JP) 2024-136913

(51) Int. Cl. G09G 3/36

(52) U.S. Cl. CPC G09G 3/3655; G09G 2300/0842; G09G 2310/0245; G09G 2310/08; G09G 2320/0247; G09G 2330/021

(57) ABSTRACT

A liquid crystal display device includes a pixel including a first memory circuit, a second memory circuit, and a display circuit including a liquid crystal capacitance and connected to the first memory circuit and the second memory circuit, a first power source line and a second power source line each connected to the display circuit, a refresh circuit for reading memory data stored in the first memory circuit and writing back the memory data to the first memory circuit in accordance with a result of the reading, and a control circuit for controlling the refresh circuit.

### CROSS-REFERENCE TO RELATED APPLICATIONS

This application claims the benefit of priority to Japanese Patent Application Number 2024-136913 filed on Aug. 16, 2024. The entire contents of the above-identified application are hereby incorporated by reference.

### BACKGROUND

### Technical Field

The disclosure relates to a liquid crystal display device.

JP 2012-93436 A discloses a liquid crystal display device including a DRAM memory in a pixel.

### SUMMARY

There is a problem that power consumption required for refresh is large in a known memory display type liquid crystal display device.

A liquid crystal display device according to an embodiment of the disclosure includes a pixel including a first memory circuit, a second memory circuit, and a display circuit including a liquid crystal capacitance and connected to the first memory circuit and the second memory circuit, a first power source line and a second power source line each connected to the display circuit, a refresh circuit for reading memory data stored in the first memory circuit and writing back the memory data to the first memory circuit in accordance with a result of the reading, and a control circuit for controlling the refresh circuit.

In a liquid crystal display device that can perform memory display, power consumption required for refresh is reduced.

### BRIEF DESCRIPTION OF DRAWINGS

The disclosure will be described with reference to the accompanying drawings, wherein like numbers reference like elements.

FIG. 1 is a block diagram illustrating a configuration of portions of a liquid crystal display device according to the embodiment.

FIG. 2 is a circuit diagram illustrating a pixel configuration example of a liquid crystal display device.

FIG. 3 is a schematic view illustrating an operation example of a liquid crystal display device according to the embodiment.

FIG. 4 is a schematic view illustrating an operation example of a liquid crystal display device according to the embodiment.

FIG. 5 is a schematic view illustrating an operation example of a liquid crystal display device according to the embodiment.

FIG. 6 is a schematic view illustrating an operation example of a liquid crystal display device according to the embodiment.

FIG. 7 is a schematic view illustrating an operation example of a liquid crystal display device according to the embodiment.

FIG. 8 is a schematic view illustrating an operation example of a liquid crystal display device according to the embodiment.

FIG. 9 is a schematic view illustrating an operation example of a liquid crystal display device according to the embodiment.

FIG. 10 is a schematic view illustrating an operation example of a liquid crystal display device according to the embodiment.

FIG. 11 is a schematic view illustrating an operation example of a liquid crystal display device according to the embodiment.

FIG. 12 is a schematic view illustrating an operation example of a liquid crystal display device according to the embodiment.

FIG. 13 is a schematic view illustrating an operation example of a liquid crystal display device according to the embodiment.

FIG. 14 is a schematic view illustrating an operation example of a liquid crystal display device according to the embodiment.

FIG. 15 is a timing chart showing an example of signal waveforms of a first and a second data lines and a first and a second control lines.

FIG. 16 is a timing chart showing an example of signal waveforms of the first and the second control lines.

FIG. 17 is a schematic view illustrating a stable state in a liquid crystal display device.

FIG. 18 is a schematic view illustrating a transition state 1 in a liquid crystal display device.

FIG. 19 is a schematic view illustrating a transition state 2 in a liquid crystal display device.

FIG. 20 is a schematic view illustrating a transition state 3 in a liquid crystal display device.

FIG. 21 is a schematic view illustrating a transition state 4 in a liquid crystal display device.

FIG. 22 is a schematic view illustrating a transition state 5 in a liquid crystal display device.

FIG. 23 is a schematic view illustrating a transition state 6 in a liquid crystal display device.

FIG. 24 is a schematic view illustrating a stable state Y1 in a liquid crystal display device.

FIG. 25 is a schematic view illustrating a transition state 7 in a liquid crystal display device.

FIG. 26 is a schematic view illustrating a stable state Y2 in a liquid crystal display device.

FIG. 27 is a schematic view illustrating a transition state 6Z in a liquid crystal display device.

FIG. 28 is a schematic view illustrating a stable state Z in a liquid crystal display device.

FIG. 29 is a schematic view illustrating a state in a rewrite period of a liquid crystal display device.

FIG. 30 is a schematic view illustrating a rewrite completion state of a liquid crystal display device.

FIG. 31 is a schematic view illustrating a configuration of a refresh circuit.

FIG. 32 is a circuit diagram illustrating a known memory type liquid crystal display device.

### DESCRIPTION OF EMBODIMENTS

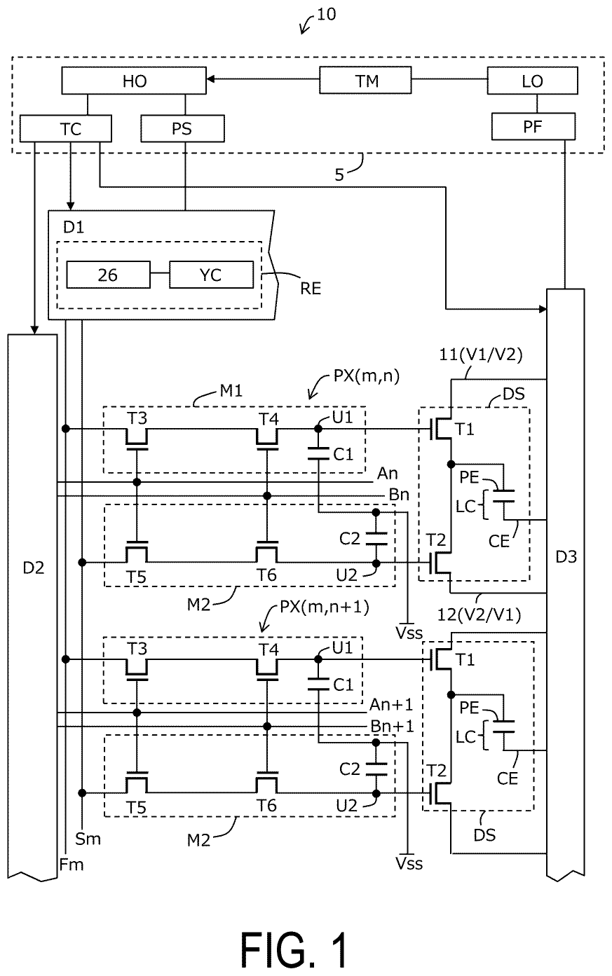

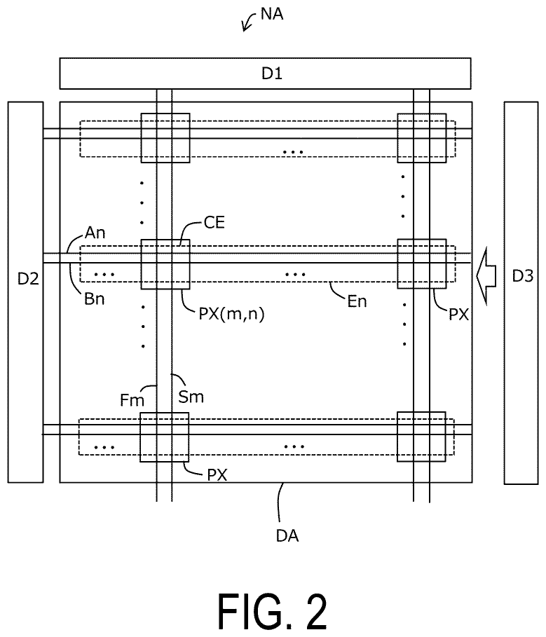

FIG. 1 is a block diagram illustrating a configuration of portions of a liquid crystal display device according to the embodiment. FIG. 2 is a circuit diagram illustrating a pixel configuration example of a liquid crystal display device. As illustrated in FIGS. 1 and 2, a liquid crystal display device 10 includes a pixel PX including a first memory circuit M1, a second memory circuit M2, and a display circuit DS including a liquid crystal capacitance LC and connected to the first memory circuit M1 and the second memory circuit M2, a first power source line 11 and a second power source line 12 each connected to the display circuit DS, a refresh circuit RE for reading memory data stored in the first memory circuit M1 and writing back the memory data to the first memory circuit M1 in accordance with a result of the reading, and a control circuit 5 for controlling the refresh circuit RE. A pixel PX (m, n) in FIGS. 1 and 2 is one (a pixel in an m-th column and an n-th row) of a pixel group arranged in, for example, a matrix shape. As illustrated in FIG. 2, the liquid crystal display device 10 may include a display region DA in which the pixel group including the pixel PX (m, n) is provided and a non-display region NA in which the refresh circuit RE is provided.

In the liquid crystal display device 10, since the refresh circuit RE reads memory data from the first memory circuit M1 and writes back the memory data to the first memory circuit M1, for example, in a predetermined cycle, the load of the control circuit 5 is reduced and the power consumption required for refreshing (reading and writing-back) is reduced. The memory data may be binary data.

The control circuit 5 may include a timer TM, a low-frequency oscillator LO, a high-frequency oscillator HO, a timing controller TC, a low-frequency power source circuit PF, and a high-frequency power source circuit PS. The timing controller TC may output various signals (including an image signal, a control signal, and a clock signal) to a first to a third driver circuits D1 to D3. The power source circuit PF may be connected to the third driver circuit D3. Refresh may be performed by activating the high-frequency oscillator HO and the power source circuit PS with the timer TM (low power consumption type) that operates with a low-frequency signal from the low-frequency oscillator LO.

The refresh circuit RE may write back inverted data of the memory data read from the first memory circuit M1 to the first memory circuit M1. When the memory data read from the first memory circuit M1 is “1 (voltage VH)”, “0 (voltage VL)”, which is the inverted data of the memory data, may be written back to the first memory circuit M1. When the memory data read from the first memory circuit M1 is “0 (voltage VL)”, “1 (voltage VH)”, which is the inverted data of the memory data, may be written back to the first memory circuit M1.

The refresh circuit RE may write back the same memory data read from the first memory circuit M1 to the second memory circuit M2. When the memory data read from the first memory circuit M1 is “1 (voltage VH)”, the same data “1 (voltage VH)” may be written back to the second memory circuit M2. When the memory data read from the first memory circuit M1 is “0 (voltage VL)”, the same data “0 (voltage VL)” may be written back to the second memory circuit M2.

The refresh circuit RE may receive an instruction from the control circuit 5 and perform writing-back within a memory maintaining period of the first memory circuit M1. The memory maintaining period is a period in accordance with characteristics of the first memory circuit M1 including transistors and capacitances, and may be, for example, several hundred seconds.

The potentials of the first power source line 11 and the second power source line 12 may be exchanged to each other in accordance with the writing-back. For example, when the first power source line 11 is at a potential V1 and the second power source line 12 is at a potential V2 before the writing-back, the first power source line 11 may be exchanged to the potential V2 and the second power source line 12 may be exchanged to the potential V1 in accordance with the writing-back.

The control circuit 5 may include the timer TM and the timing controller TC, and the timing controller TC activated by the timer TM may control the refresh circuit RE. The refresh circuit RE may stop after the writing-back by the refresh circuit RE, or the timing controller TC may stop after the writing-back.

The liquid crystal display device 10 may include a first data line Fm connected to the first memory circuit M1 and a second data line Sm connected to the second memory circuit M2. The display circuit DS may include a first transistor T1 connected to the first memory circuit M1 and a second transistor T2 connected to the second memory circuit M2. The liquid crystal capacitance LC of the display circuit DS may include a pixel electrode PE and a counter electrode CE. The pixel electrode PE may be connected to the first power source line 11 via the first transistor T1 and may be connected to the second power source line 12 via the second transistor T2.

In the liquid crystal display device 10, a refresh period in which reading and writing-back are performed by the refresh circuit RE and a hold period in which the memory data of each of the first and second memory circuits M1 and M2 are maintained may be provided. Further, a rewrite period for rewriting the memory data of each of the first and second memory circuits M1 and M2 may be provided. A rewrite interval may include a plurality of the refresh periods and a plurality of the hold periods.

The liquid crystal display device 10 may include a first control line An for controlling the first memory circuit M1 and a second control line Bn for controlling the second memory circuit M2, and drive signals output to the first and second control lines An and Bn may be inverted during the hold period. For example, the second control line Bn may be inverted from “L” to “H” in accordance with the first control line An being inverted from “H” to “L”. In this way, a shift of a threshold voltage of the transistor in each of the first and second memory circuits M1 and M2 can be reduced. In synchronization with the transition of the first control line An from “H” to “L” to “L”, the second control line Bn may transit from “L” to “L” to “H”. In this way, a problem that the first and second control lines An and Bn unintentionally become “H” at the same time and the memory voltage changes can be prevented.

The potential supplied to the counter electrode CE may be exchanged in accordance with the writing-back. For example, when a potential (counter potential) supplied to the counter electrode CE before the writing-back is the potential V2, the counter potential may be exchanged to the potential V1 in accordance with the writing-back.

The refresh circuit RE may include a reading circuit YC that reads memory data and a latch circuit 26 that latches the read memory data. The reading circuit YC may include a comparison circuit (for example, an amplifier circuit) and a capacitance element. The latch circuit 26 may include a D flip-flop. In the refresh period, the refresh circuit RE may latch the memory data read from the first memory circuit M1 by the reading circuit YC in the latch circuit 26 and output inverted data of the latched memory data to the first memory circuit M1 in the refresh period.

The liquid crystal display device 10 may be provided with the first driver circuit D1 that includes the refresh circuit RE and drives the first and second data lines Fm and Sm. The first driver circuit D1 may stop during the hold period in which the memory data of each of the first and second memory circuits M1 and M2 is maintained.

The liquid crystal display device 10 may be provided with the second driver circuit D2 that drives the first control line An and the second control line Bn and the third driver circuit D3 that drives the first power source line 11 and the second power source line 12. The third driver circuit D3 may drive the counter electrode CE of the liquid crystal capacitance LC.

The refresh circuit RE may read the memory data stored in the second memory circuit M2 and notify the timing controller TC when the memory data stored in the first memory circuit M1 and the memory data stored in the second memory circuit M2 are not in an inverted relationship. The timing controller TC having received the notification may write the original data (the most recent rewrite data) to the first and second memory circuits M1 and M2.

As illustrated in FIGS. 1 and 2, the first memory circuit M1 may include a first capacitance C1, a third transistor T3, and a fourth transistor T4, and the second memory circuit M2 may include a second capacitance C2, a fifth transistor T5, and a sixth transistor T6. Gate terminals of the third and fifth transistors T3 and T5 may be connected to the first control line An, and gate terminals of the fourth and sixth transistors T4 and T6 may be connected to the second control line Bn.

The first data line Fm may be connected to a gate terminal of the first transistor T1 via the third and fourth transistors T3 and T4, and the second data line Sm may be connected to a gate terminal of the second transistor T2 via the fifth and sixth transistors T5 and T6. The gate terminal of the first transistor T1 may be connected to the first capacitance C1, and the gate terminal of the second transistor T2 may be connected to the second capacitance C2.

According to the liquid crystal display device 10, by controlling the first transistor T1 with the voltage held by the first memory circuit M1 and controlling the second transistor T2 with a voltage (memory voltage) held by the second memory circuit M2, the display voltage can be written to the pixel electrode PE from the first power source line 11 or the second power source line 12. As a result, a refresh frequency can be reduced (a refresh interval can be increased) while maintaining the quality (for example, low flicker) of memory display.

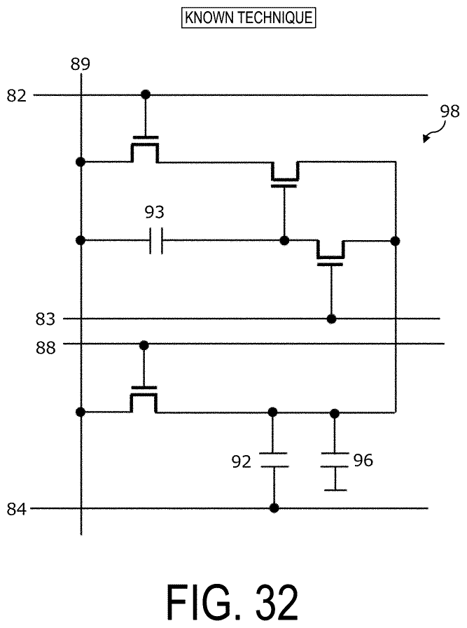

In the known art disclosed in JP 2012-93436 A (FIG. 32) (memory type liquid crystal pixel 98 connected to a refresh line 82, a data line 89, a gate line 88, a sampling line 83 and a CS line 84 and including a sampling capacitance 93, a storage capacitance 92 and a liquid crystal capacitance 96), since the storage capacitance 92 and the liquid crystal capacitance 96 are connected in parallel and a voltage of the storage capacitance 92 and a voltage of the liquid crystal capacitance 96 are held in the same configuration, and thus a luminance change is large at the time of refresh and a flicker is easily visually recognized.

On the other hand, in the liquid crystal display device 10, the memory voltages (for example, binary data) of the first and second memory circuits M1 and M2 and a voltage of the liquid crystal capacitance LC are held in separate configurations, and thus a luminance change is small at the time of refresh, and a flicker is hardly visually recognized.

During the hold period (display period), one of the first and second transistors T1 and T2 turns on and the other turns off, and thus the first potential V1 or the second potential V2 lower than the first potential V1 may be supplied to the pixel electrode PE.

The pixel PX may perform binary display of black gray scale and white gray scale. The display of the black gray scale means black display in the pixel PX. The display of the white gray scale may mean primary color display (for example, display of any one of red, green, and blue) in the pixel PX or white display in the pixel PX. When the primary color display is performed in the pixel PX, color display of eight colors is possible.

In the liquid crystal display device 10, by setting the first and second control lines An and Bn to an active potential to turn on the third to sixth transistors T3 to T6 during the writing period, one of a positive logic voltage (for example, VH) and a negative logic voltage (for example, VL) may be written from the first data line Fm to the first capacitance C1 and the other of the positive logic voltage (for example, VH) and the negative logic voltage (for example, VL) may be written from the second data line Sm to the second capacitance C2. The writing period means a period of refreshing (without changing the frame data) or a period of rewriting (with changing the frame data) a potential of an output U1 of the first memory circuit M1 and a potential of an output U2 of the second memory circuit M2.

When the pixel PX is a normally black type, the white gray scale display may be performed during a period in which the pixel electrode PE is at the first potential V1 and the counter electrode CE is at the second potential V2 and a period in which the pixel electrode PE is at the second potential V2 and the counter electrode CE is at the first potential V1, and the black gray scale display may be performed during a period in which the pixel electrode PE is at the first potential V1 and the counter electrode CE is at the first potential V1 and a period in which the pixel electrode PE is at the second potential V2 and the counter electrode CE is at the second potential V2.

When the pixel PX is a normally white type, the white gray scale display may be performed during the period in which the pixel electrode PE is at the first potential V1 and the counter electrode CE is at the first potential V1 and the period in which the pixel electrode PE is at the second potential V2 and the counter electrode CE is at the second potential V2, and the black gray scale display may be performed during the period in which the pixel electrode PE is at the first potential V1 and the counter electrode CE is at the second potential V2 and the period in which the pixel electrode PE is at the second potential V2 and the counter electrode CE is at the first potential V1.

The first and second transistors T1 and T2 may have the same type channel, and the positive logic potential may be stored in the first memory circuit M1 and the negative logic potential may be stored in the second memory circuit M2, so that the first transistor T1 may turn on and the second transistor T2 may turn off, and the negative logic potential may be stored in the first memory circuit M1 and the positive logic potential may be stored in the second memory circuit M2, so that the first transistor T1 may turn off and the second transistor T2 may turn on.

When the first and second transistors T1 and T2 have N-type channels, the positive logic potential may be VH (memory potential on a high potential side) and the negative logic potential may be VL (memory potential on a low potential side), and when the first and second transistors T1 and T2 have P-type channels, the positive logic potential may be VL (memory potential on the low potential side) and the negative logic potential may be VH (memory potential on the high potential side).

In the pixel PX, the first and second transistors T1 and T2 may alternately turn on during the display period of the white gray scale. In this way, a characteristic change (shift in I-V characteristics) that may occur when a transistor turns on for a long period of time can be avoided for the first and second transistors T1 and T2. In accordance with the first and second transistors T1 and T2 being alternately turned on, the potentials (power source potentials) of the first and second power source lines 11 and 12 may be exchanged to each other, or the potential of the counter electrode CE may be exchanged.

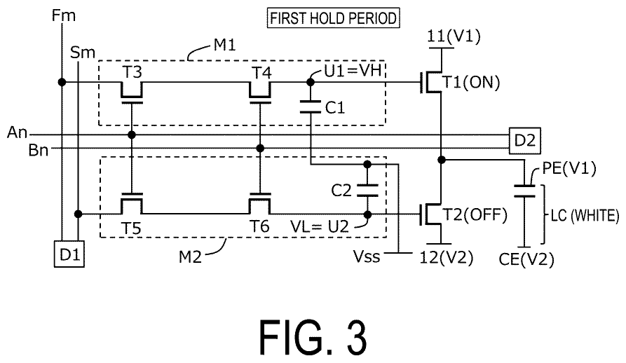

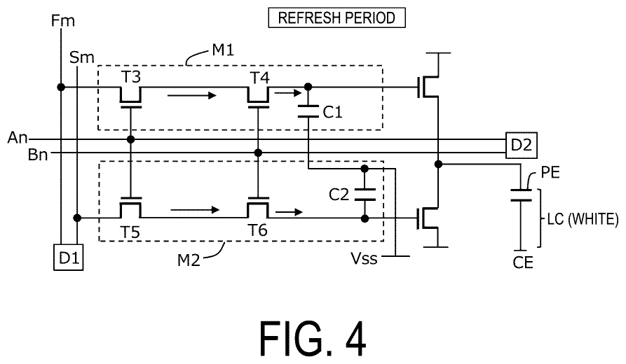

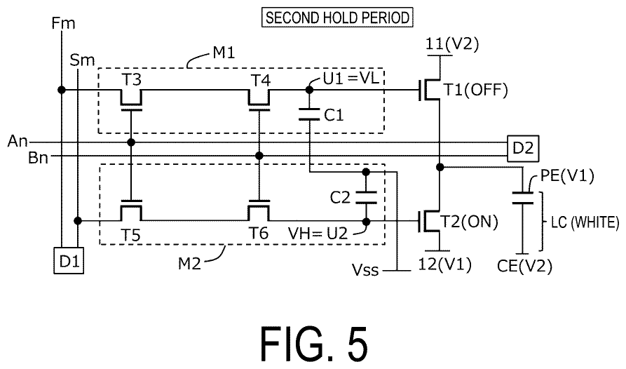

FIGS. 3 to 5 are schematic views each illustrating an operation example of a liquid crystal display device according to the embodiment. As illustrated in FIGS. 3 to 5, the display period of the white gray scale in the normally black type may include a first hold period in which the first transistor T1 turns on (T2 turns off) and the first potential V1 is supplied from the first power source line 11 to the pixel electrode PE and the second potential V2 is supplied to the counter electrode CE, and a second hold period in which the second transistor T2 turns on (T1 turns off) and the first potential V1 is supplied from the second power source line 12 to the pixel electrode PE and the second potential V2 is supplied to the counter electrode CE, and the refresh period may be provided between the first hold period and the second hold period.

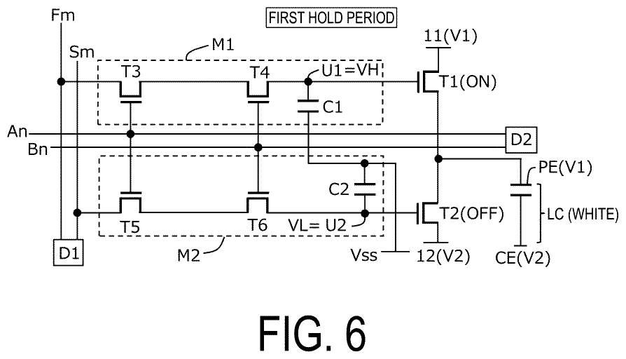

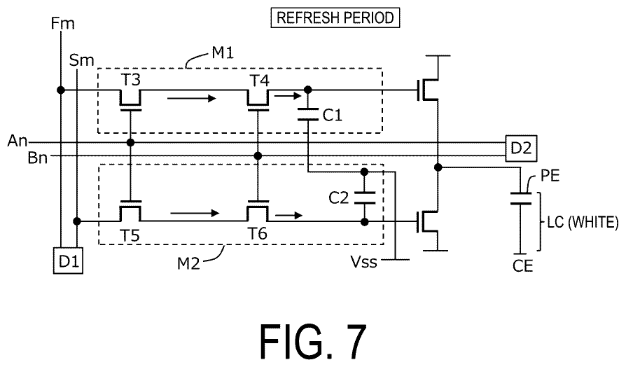

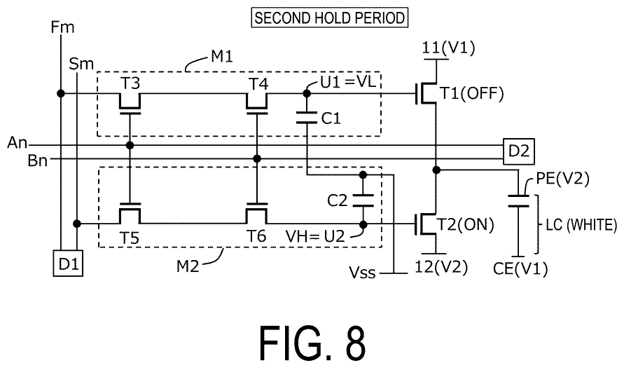

FIGS. 6 to 8 are schematic views each illustrating an operation example of a liquid crystal display device according to the embodiment. As illustrated in FIGS. 6 to 8, the display period of the white gray scale in the normally black type may include a first hold period in which the first transistor T1 turns on (T2 turns off) and the first potential V1 is supplied from the first power source line 11 to the pixel electrode PE and the second potential V2 is supplied to the counter electrode CE, and a second hold period in which the second transistor T2 turns on (T1 turns off) and the second potential V2 is supplied from the second power source line 12 to the pixel electrode PE and the first potential V1 is supplied to the counter electrode CE, and the refresh period may be provided between the first hold period and the second hold period.

In the pixel PX, the first and second transistors may alternately turn on during the display period of the black gray scale. In this way, the characteristic change (shift in I-V characteristics) that may occur when a transistor turns on or off for a long period of time can be avoided for the first and second transistors T1 and T2. In accordance with the first and second transistors T1 and T2 being alternately turned on, the potentials (power source potentials) of the first and second power source lines 11 and 12 may be exchanged to each other, or the potential of the counter electrode CE may be exchanged.

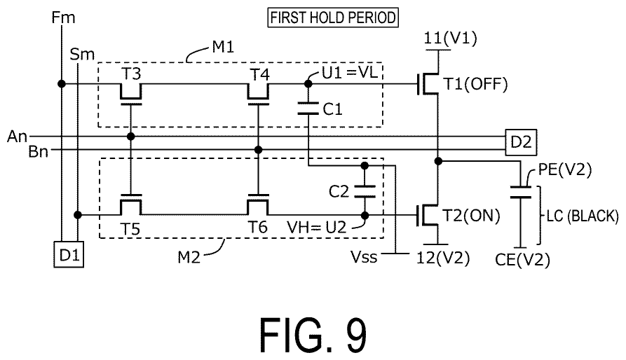

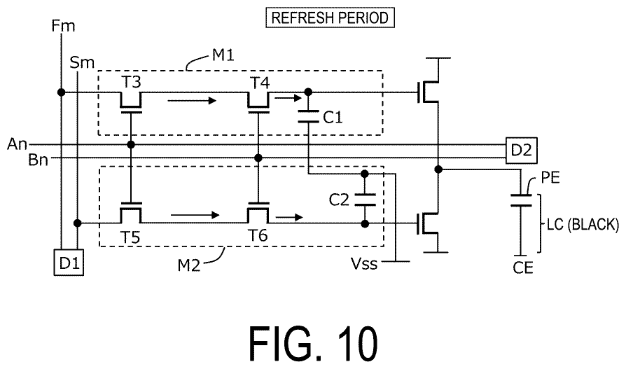

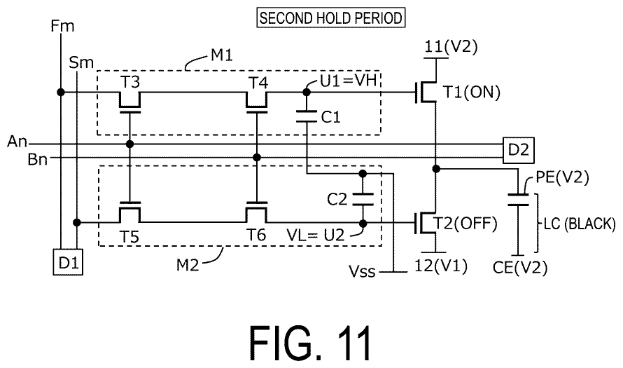

FIGS. 9 to 11 are schematic views each illustrating an operation example of a liquid crystal display device according to the embodiment. As illustrated in FIGS. 9 to 11, the display period of the black gray scale in the normally black type may include a first hold period in which the second transistor T2 turns on (T1 turns off) and the second potential V2 is supplied from the second power source line 12 to the pixel electrode PE and the second potential V2 is supplied to the counter electrode CE, and a second hold period in which the first transistor T1 turns on (T2 turns off) and the second potential V2 is supplied from the first power source line 11 to the pixel electrode PE and the second potential V2 is supplied to the counter electrode CE, and the refresh period may be provided between the first hold period and the second hold period.

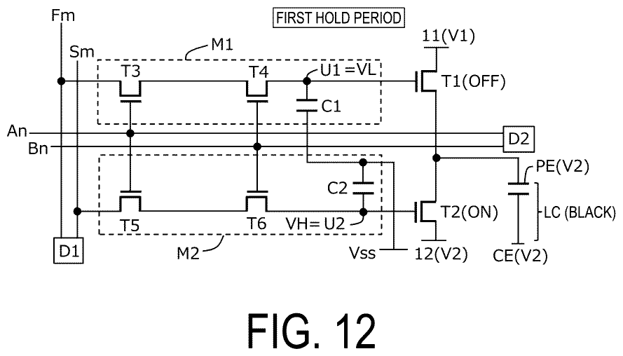

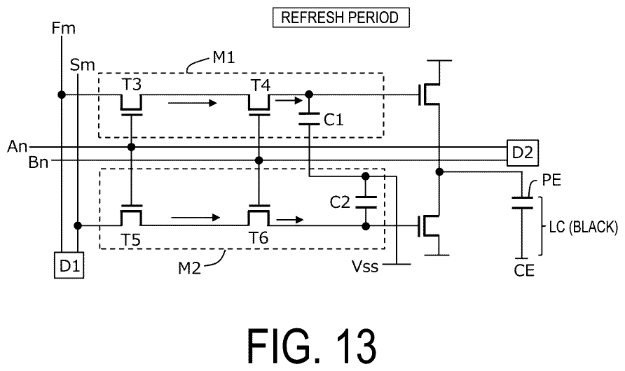

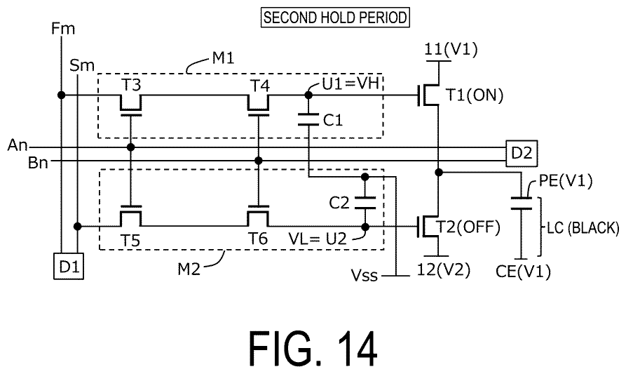

FIGS. 12 to 14 are schematic views each illustrating an operation example of a liquid crystal display device according to the embodiment. As illustrated in FIGS. 12 to 14, the display period of the black gray scale in the normally black type may include a first hold period in which the second transistor T2 turns on (T1 turns off) and the second potential V2 is supplied from the second power source line 12 to the pixel electrode PE and the second potential V2 is supplied to the counter electrode CE, and a second hold period in which the first transistor T1 turns on (T2 turns off) and the first potential V1 is supplied from the first power source line 11 to the pixel electrode PE and the first potential V1 is supplied to the counter electrode CE, and the refresh period may be provided between the first hold period and the second hold period.

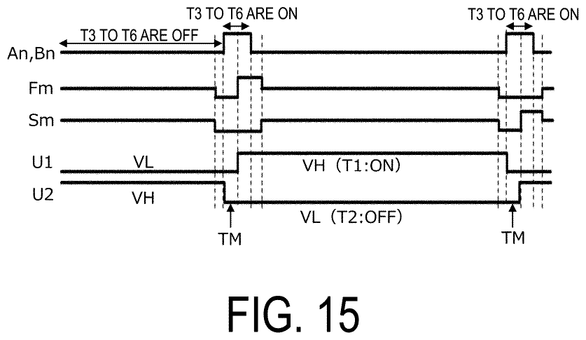

FIG. 15 is a timing chart showing an example of signal waveforms of a first and a second data lines and a first and a second control lines. As illustrated in FIG. 15, a period may be included in which transition is performed from a state in which the first transistor T1 is on (U1 is VH) and the second transistor T2 is off (U2 is VL) to a state in which the first and second transistors T1 and T2 are simultaneously off (U1 and U2 are VL) and then to a state in which the first transistor T1 is off (U1 is VL) and the second transistor T2 is on (U2 is VH). As described above, by providing a period TM in which the first and second transistors T1 and T2 simultaneously turn off (U1 and U2 are VL) before the transition of the state of each of the first and second transistors T1 and T2, the short circuit of the first and second power source lines 11 and 12 due to the first and second transistors T1 and T2 simultaneous turning on can be avoided.

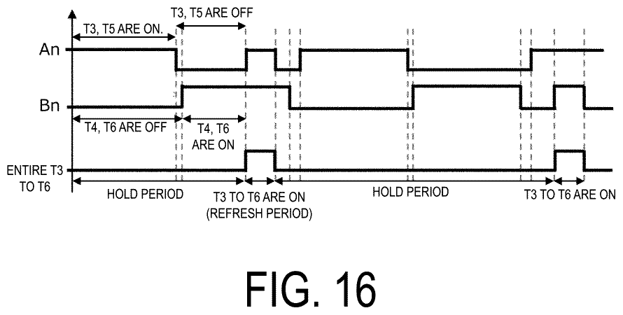

FIG. 16 is a timing chart showing an example of signal waveforms of the first and the second control lines. In the liquid crystal display device 10, one of the first and second control lines An and Bn may be at an active potential and the other may be at a non-active potential during the hold period (a period during which the outputs U1 and U2 of the first and second memory circuits M1 and M2 are maintained). In this way, the third and fifth transistors T3 and T5 can be turned on (T4 and T6 are turned off) and the fourth and sixth transistors T4 and T6 can be turned on (T3 and T5 are turned off) while maintaining the potential (memory potential) of the output node U1 of the first memory circuit M1 and the potential (memory potential) of the output node U2 of the second memory circuit M2. As a result, the characteristic change (shift in I-V characteristics) that may occur when each of the third to sixth transistors T3 to T6 is turned on or off for a long period of time can be reduced.

In the hold period, the first and second control lines An and Bn may be alternately at the active potential. In this way, each of the third to sixth transistors T3 to T6 can be periodically turned on and off, and the characteristic change of each transistor can be more effectively reduced.

As illustrated in FIG. 16, in the hold period, in order to prevent the third to sixth transistors from simultaneously turning on, it is desirable that a potential shift timing (for example, fall) of a pulse of the first control line An and a potential shift timing (for example, rise) of a pulse of the second control line Bn are shifted from each other.

In the liquid crystal display device 10, the first to sixth transistors T1 to T6 may have the same type channel, and the first to sixth transistors T1 to T6 may have channels containing oxide semiconductors. At least one of the first to sixth transistors T1 to T6 may have an N-type channel containing an oxide semiconductor. The oxide semiconductor may be indium gallium zinc oxide.

In the liquid crystal display device 10, a pixel row PL including a plurality of the pixels PX arranged in the row direction may share the first and second power source lines 11 and 12, and the pixel row PL may share the counter electrode CE. The pixel row PL may share the first and second power source lines 11 and 12 and the counter electrode CE.

The liquid crystal display device 10 is suitable for so-called digital signage. In a display for signage, a transistor for sampling and holding turns off for a long period of time, and transistor characteristics may change; however, in the liquid crystal display device 10, the states of not only the first and second transistors T1 and T2 but also the third to sixth transistors T3 to T6 can be periodically transitioned (from on to off, from off to on) while maintaining the display state (memory display). Thus, the possibility that the transistor characteristics change is reduced.

For example, in the case of a transistor having an N-type channel, when an off period (gate voltage=off voltage) continues for a long period of time, V-I characteristics shift to a low voltage side, and then a current flows even when the gate voltage is the off voltage, and the transistor does not function as a current control element. On the other hand, when an on period (gate voltage=on voltage) continues for a long period of time, the V-I characteristics shift to a high voltage side, and then a current decreases even when the gate voltage is the on voltage, and the transistor does not function as the current control element. A tendency of such a characteristic change is also observed in a transistor whose channel is the oxide semiconductor. Thus, as in the liquid crystal display device 10, the gate potentials of not only the first and second transistors T1 and T2 but also the third to sixth transistors T3 to T6 are periodically exchanged to the off voltage or the on voltage, so that the V-I characteristics can be fixed and the transistors can appropriately function as the current control elements. As a result, power consumption can be reduced while maintaining the quality of the memory display such as low flicker.

As described above, in the liquid crystal display device 10, a still image can be displayed (memory display) with low power consumption and high quality over a long period of time, but moving picture display can also be displayed by increasing a write frequency.

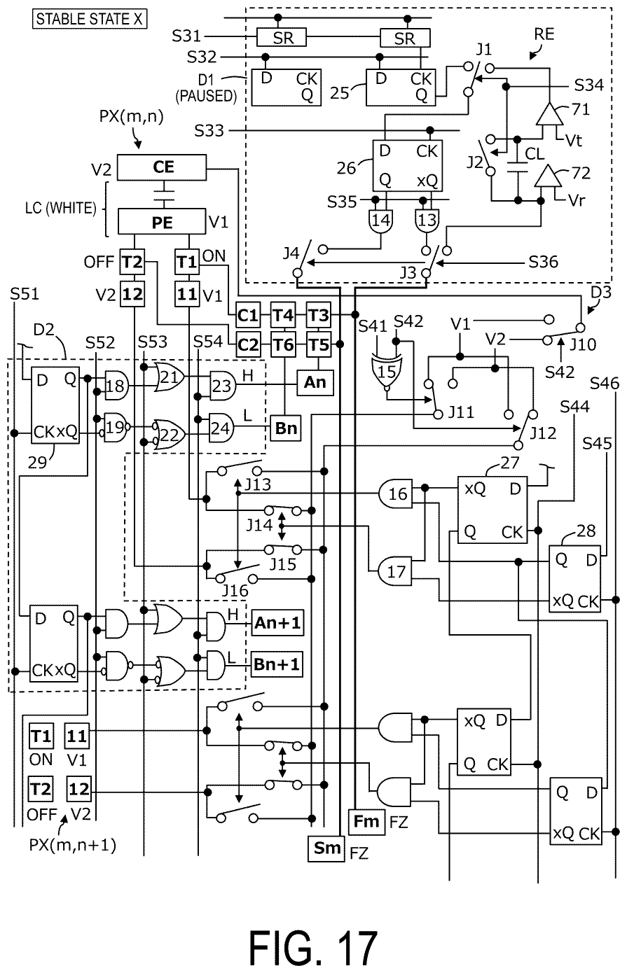

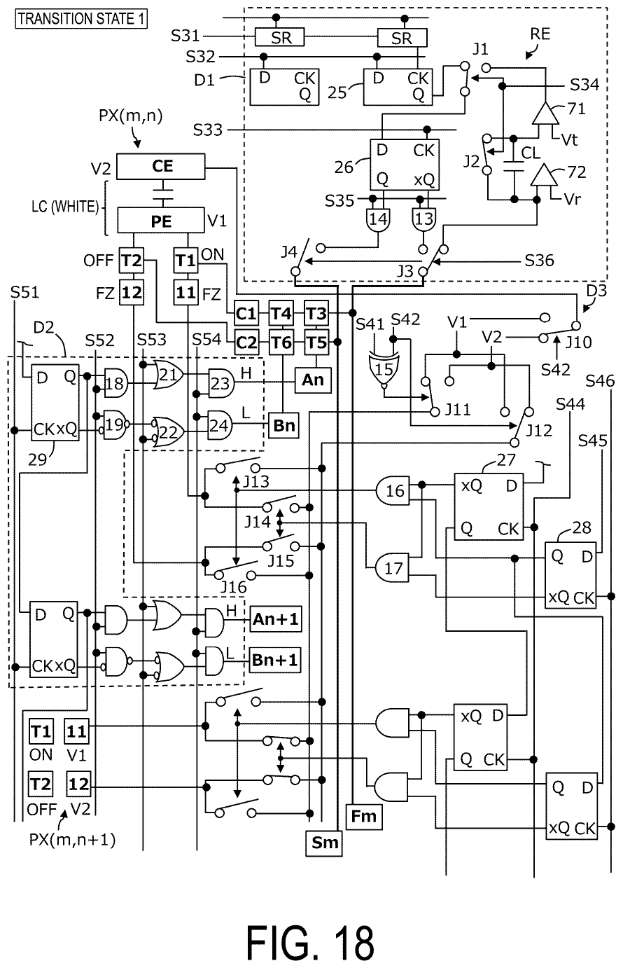

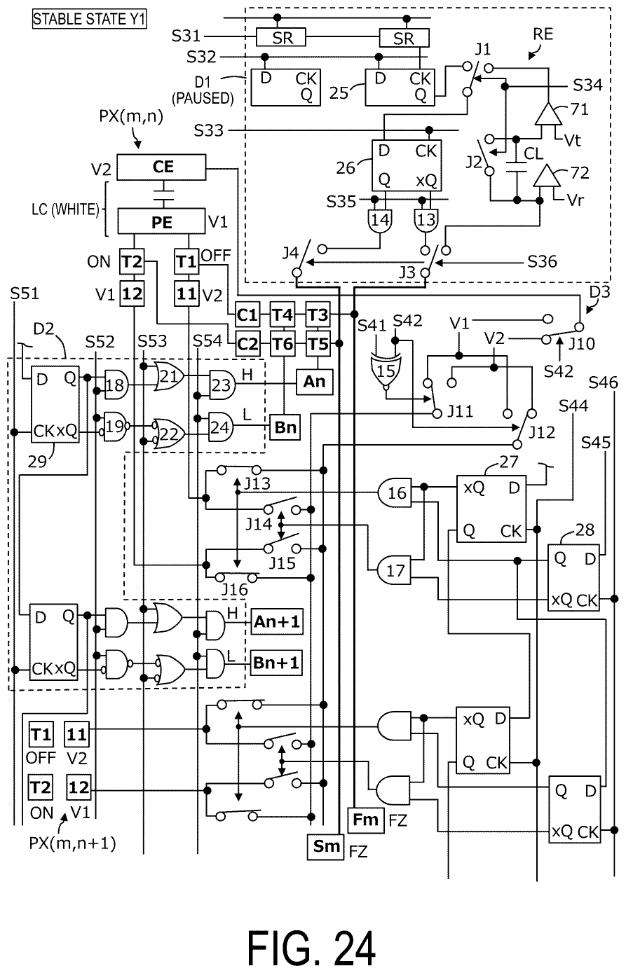

FIG. 17 is a schematic view illustrating a stable state in a liquid crystal display device. FIGS. 18 to 23 are schematic views each illustrating a transition state. FIG. 24 is a schematic view illustrating a stable state in a liquid crystal display device. As illustrated in FIGS. 17 to 24, the first driver circuit D1 includes a shift register SR, a D flip-flop 25, and a refresh circuit RE. A signal S31 is input to the shift register SR. The output of the shift register SR is input to a CK terminal of the D flip-flop 25. A signal S32 is input to a D terminal of the D flip-flop 25. The refresh circuit RE includes a D flip-flop 26, AND circuits 13 and 14, switch circuits (selection circuits) J1 to J4, amplifier circuits 71 and 72, and a capacitance element CL.

The amplifier circuits 71 and 72, the capacitance element CL, and the switch circuits J1 and J2 constitute a reading circuit. The switch circuits J1 and J2 are controlled by a signal S34, and the switch circuits J3 and J4 are controlled by a signal S36. A signal S33 is input to a CK terminal of the D flip-flop 26.

In the refresh circuit RE, first input ends of the amplifier circuits 71 and 72 are connected to each other via the capacitance element CL, and the switch circuit J2 is arranged in parallel with the capacitance element CL. A second input of the amplifier circuit 71 is a reference potential Vt, and a second input of the amplifier circuit 72 is a reference potential Vr. The switch circuit J1 selectively connects the D terminal of the D flip-flop 26 to the Q terminal of the D flip-flop 25 or an output end of the amplifier circuit 71. A first input of the AND circuit 13 is an xQ signal of the D flip-flop 26, a first input of the AND circuit 14 is a Q signal of the D flip-flop 26, and a second input of each of the AND circuits 13 and 14 is a signal S35. The switch circuit J3 selectively connects the first data line Fm to an output end of the AND circuit 13 or the first input end of the amplifier circuit 72. The switch circuit J4 connects or disconnects the second data line Sm to or from the output end of the AND circuit 14.

The second driver circuit D2 includes a D flip-flop 29, AND circuits 18, 23, and 24, a NAND circuit 19, and OR circuits 21 and 22. A signal S51 is input to a CK terminal of the D flip-flop 29. A first input of the AND circuit 18 is a Q signal of the D flip-flop 29, a first input of the NAND circuit 19 is an inverted signal of an xQ signal of the D flip-flop 29, and a second input of each of the AND circuit 18 and the NAND circuit 19 is a signal S52. A first input of the OR circuit 21 is an output of the AND circuit 18, a first input of the OR circuit 22 is an inverted output of the AND circuit 19, a second input of the OR circuit 21 is a signal S53, and a second input of the OR circuit 22 is an inverted signal of the signal S53. A first input of the AND circuit 23 is an output of the OR circuit 21, a first input of the AND circuit 24 is an output of the OR circuit 22, and a second input of each of the AND circuits 23 and 24 is a signal S54.

The third driver circuit D3 includes switch circuits J10 to J16, D flip-flops 27 and 28, an XNOR circuit 15, AND circuits 16 and 17, a first voltage source (V1 source), and a second voltage source (V2 source). Signals S41 and S42 are input to the XNOR circuit 15. The switch circuits J10 and J12 are controlled by the signal S42. A first input of the XNOR circuit 15 is the signal S41, a second input of the XNOR circuit 15 is the signal S42, and the switch circuit J11 is controlled by an output of the XNOR circuit 15. The switch circuits J13 and J16 are controlled by an output of the AND circuit 16. The switch circuits J14 and J15 are controlled by an output of the AND circuit 17. A signal S44 is input to a CK terminal of the D flip-flop 27. A signal S45 is input to a D terminal of the D flip-flop 28, and a signal S46 is input to a CK terminal of the D flip-flop 28. A first input of each of the AND circuits 16 and 17 is an xQ signal of the D flip-flop 27, a second input of the AND circuit 16 is a Q signal of the D flip-flop 28, and a second input of the AND circuit 17 is an xQ signal of the D flip-flop 28.

The switch circuit J10 selectively connects the counter electrode CE to the first voltage source (V1 source) or the second voltage source (V2 source). The first power source line 11 is connected to the first voltage source (V1 source) via the switch circuits J11 and J14, and is connected to the second voltage source (V2 source) via the switch circuits J12 and J13. The second power source line 12 is connected to the first voltage source (V1 source) via the switch circuits J11 and J16, and is connected to the second voltage source (V2 source) via the switch circuits J12 and J15.

FIG. 17 illustrates a stable state X (FIG. 3) in which the first driver circuit D1 (including the refresh circuit RE) stops and the first and second data lines Fm and Sm are in a floating state FZ (high impedance state). “1 (voltage VH)” is stored in the first memory circuit M1 (T3, T4, C1) and “0 (voltage VL)” is stored in the second memory circuit M2 (T5, T6, C2), and thus the first transistor T1 turns on and the second transistor T2 turns off.

By the second driver circuit D2, the first control line An is set to “H (High)” and the second control line Bn is set to “L (Low)”, and thus the third and fifth transistors T3 and T5 turn on and the fourth and sixth transistors T4 and T6 turn off. In the third driver circuit D3, the switch circuit J11 and the switch circuit J12 are connected to the first voltage source (V1 source) and the second voltage source (V2 source), respectively, and the switch circuits J14 and J15 turn on and the switch circuits J13 and J16 turn off, and thus the first power source line 11, the second power source line 12, and the counter electrode CE are set (driven) to V1, V2, and V2, respectively. As a result, a potential of the pixel electrode PE is maintained at V1, and the liquid crystal capacitance LC displays white.

FIG. 18 is a schematic view illustrating a transition state 1. In FIG. 18, the first driver circuit D1 (including the refresh circuit RE) is activated, the switch circuit J1 connects the D terminal of the D flip-flop 26 to the Q terminal of the D flip-flop 25, the switch circuit J2 turns on, and the switch circuit J3 connects the first data line Fm to the first input end of the amplifier circuit 72. The first data line Fm is precharged up to the reference potential Vr. In the second driver, the Q signal of the D flip-flop 29 becomes active, but since a signal 52 (strobe signal) is non-active, the potential states of the first and second control lines An and Bn do not change. In the third driver, outputs (Q signal and xQ signal) of the D flip-flop 27 become active, and the switch circuits J14 and J15 turn off. As a result, the first and second power source lines 11 and 12 becomes the floating state FZ (high impedance state).

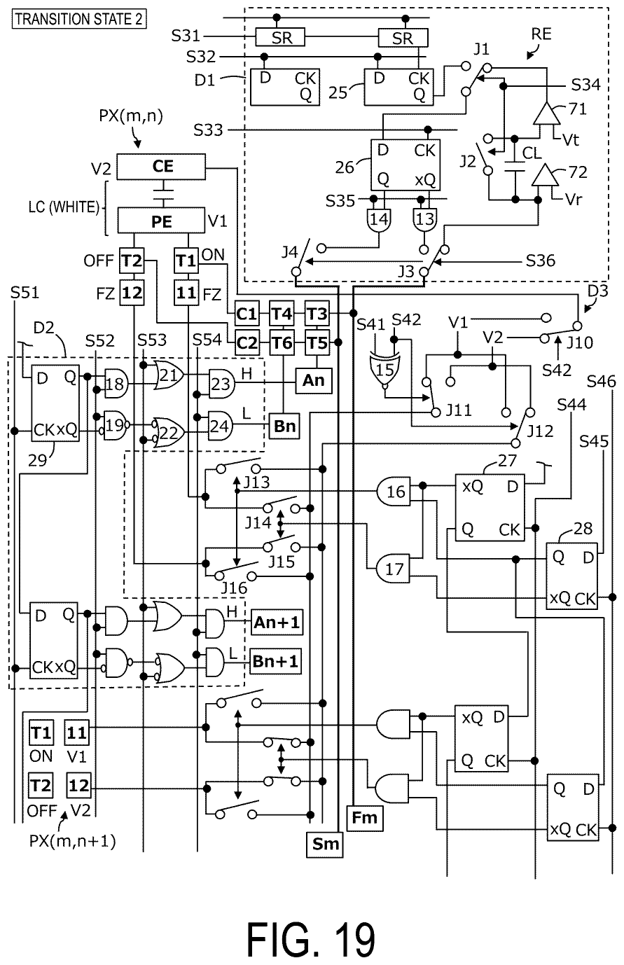

FIG. 19 is a schematic view illustrating a transition state 2. In FIG. 19, the switch circuit J1 connects the D terminal of the D flip-flop 26 to the output end of the amplifier circuit 71, and the switch circuit J2 turns off. In the third driver, outputs (Q signal and xQ signal) of the D flip-flop 28 are activated. As a result, the reading preparation is completed.

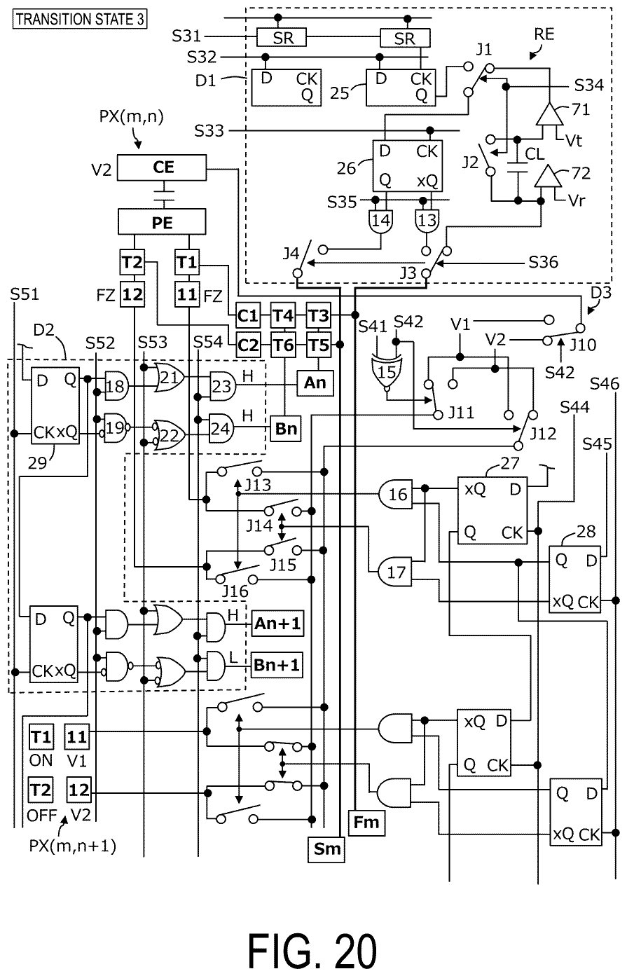

FIG. 20 is a schematic view illustrating a transition state 3. In FIG. 20, the signal 52 (strobe signal) becomes active, both the first and second control lines An and Bn become “H”, and the third to sixth transistors T3 to T6 turn on. As a result, the memory data “1 (voltage VH)” of the first memory circuit M1 is read out to the refresh circuit RE via the transistors T3 and T4, the first data line Fm, and the switch circuit J13. That is, after the electric charge of the first capacitance C1 is I-V converted, the amplifier circuit 71 determines whether the electric charge is “0” or “1”, and the result is latched by the D flip-flop 26 (latch circuit).

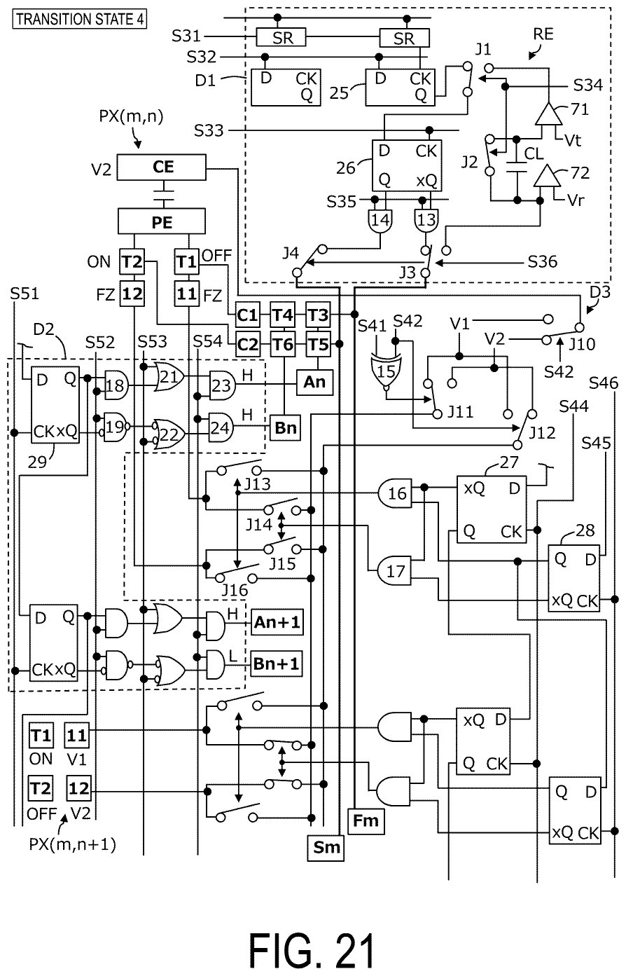

FIG. 21 is a schematic view illustrating a transition state 4. In FIG. 21, the switch circuit J1 connects the D terminal of the D flip-flop 26 to the Q terminal of the D flip-flop 25, the switch circuit J3 connects the first data line Fm to the output end of the AND circuit 13, and the switch circuit J4 connects the second data line Sm to the output end of the AND circuit 14. As a result, the inverted data “0” of the latched data “1” of the D flip-flop 26 is written back to the first memory circuit M1 (the first capacitance C1) via the switch circuit J3, the first data line Fm, and the transistors T3 and T4, and the same data “1” of the latched data “1” of the D flip-flop 26 is written back to the second memory circuit M2 (the second capacitance C2) via the switch circuit J4, the second data line Sm, and the transistors T5 and T6. As a result, the first transistor T1 turns off and the second transistor T2 turns on.

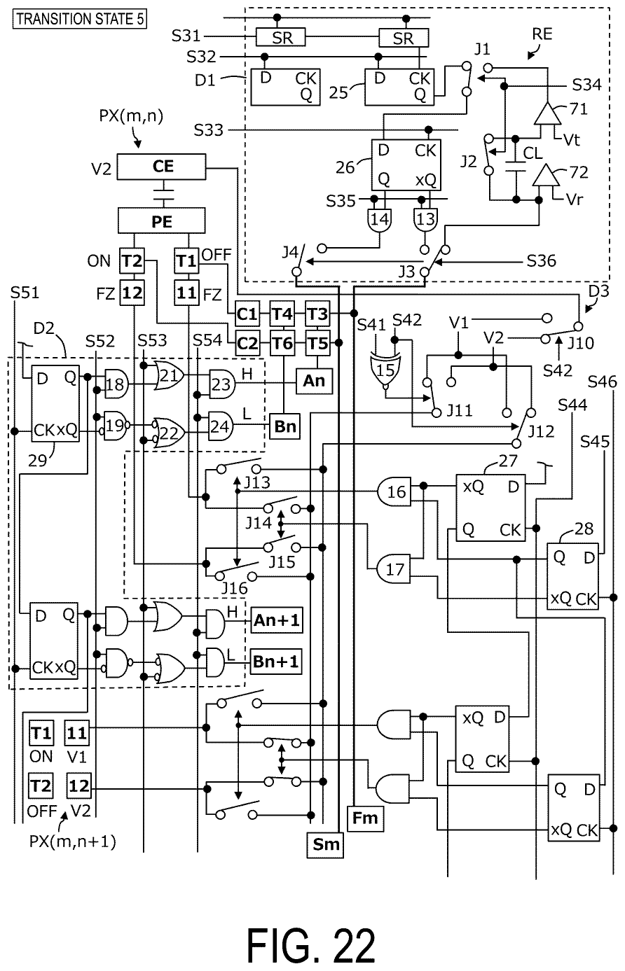

FIG. 22 is a schematic view illustrating a transition state 5. In FIG. 22, the switch circuit J3 connects the first data line Fm to the first input end of the amplifier circuit 72, and the switch circuit J4 turns off. In the second driver circuit D2, the second control line Bn becomes “L”, and the fourth and sixth transistors T4 and T6 turn off. As a result, reading and writing-back of the pixel PX (m, n) are prohibited.

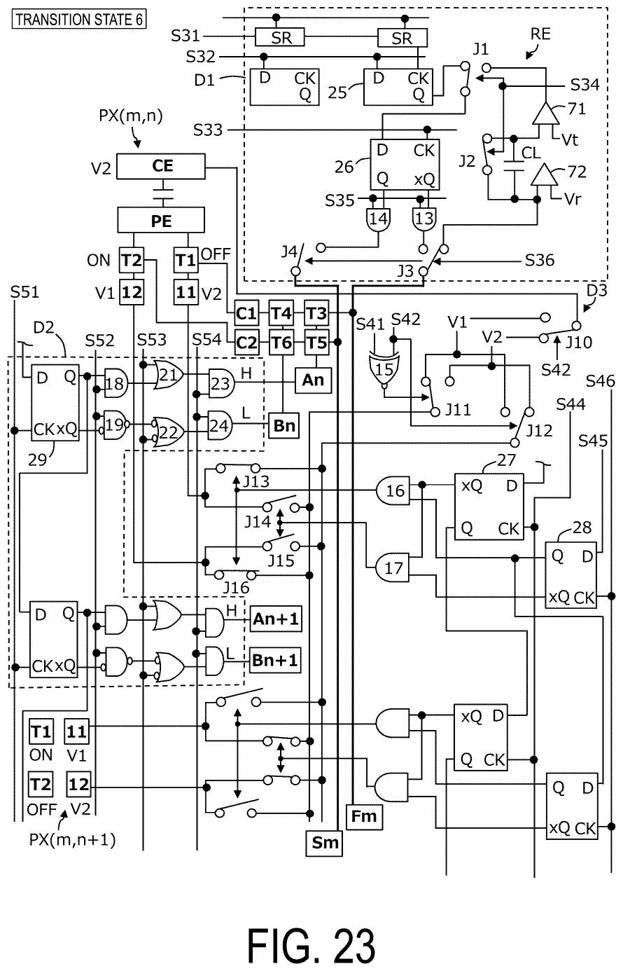

FIG. 23 is a schematic view illustrating a transition state 6. In FIG. 23, outputs (Q signal and xQ signal) of the D flip-flop 27 become non-active, and the switch circuits J13 and J16 turn on. As a result, the first power source line 11 and the second power source line 12 are charged to V2 and V1, respectively, and the refresh of the pixel PX (m, n) is completed.

FIG. 24 is a schematic view illustrating a stable state Y1. In FIG. 24, the first driver circuit D1 (including the refresh circuit RE) stops and the first and second data lines Fm and Sm are in the floating state FZ (high impedance state). “0 (voltage VH)” is stored in the first memory circuit M1 (T3, T4, C1) and “1 (voltage VL)” is stored in the second memory circuit M2 (T5, T6, C2), and thus the first transistor T1 turns off and the second transistor T2 turns on.

By the second driver circuit D2, the first control line An is set to “H (High)” and the second control line Bn is set to “L (Low)”, and thus the third and fifth transistors T3 and T5 turn on and the fourth and sixth transistors T4 and T6 turn off. In the third driver circuit D3, the switch circuit J11 and the switch circuit J12 are connected to the first voltage source (V1 source) and the second voltage source (V2 source), respectively, and the switch circuits J14 and J15 turn off and the switch circuits J13 and J16 turn on, and thus the first power source line 11, the second power source line 12, the counter electrode CE are set (driven) to V2, V1, and V2, respectively. As a result, a potential of the pixel electrode PE is maintained at V1, and the liquid crystal capacitance LC displays white.

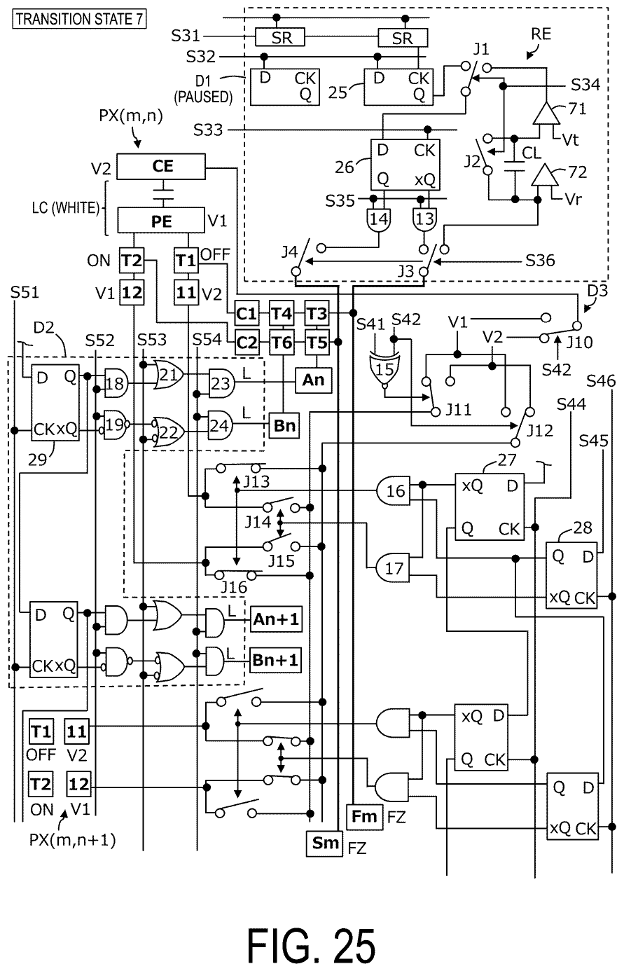

FIG. 25 is a schematic view illustrating a transition state 7 after the stable state Y1. In FIG. 25, the first driver circuit D1 (including the refresh circuit RE) stops and the first and second data lines Fm and Sm are in the floating state FZ (high impedance state). By the second driver circuit D2, both the first control line An and the second control line Bn are set to “L (Low)” and the third to sixth transistors T3 to T6 turn off.

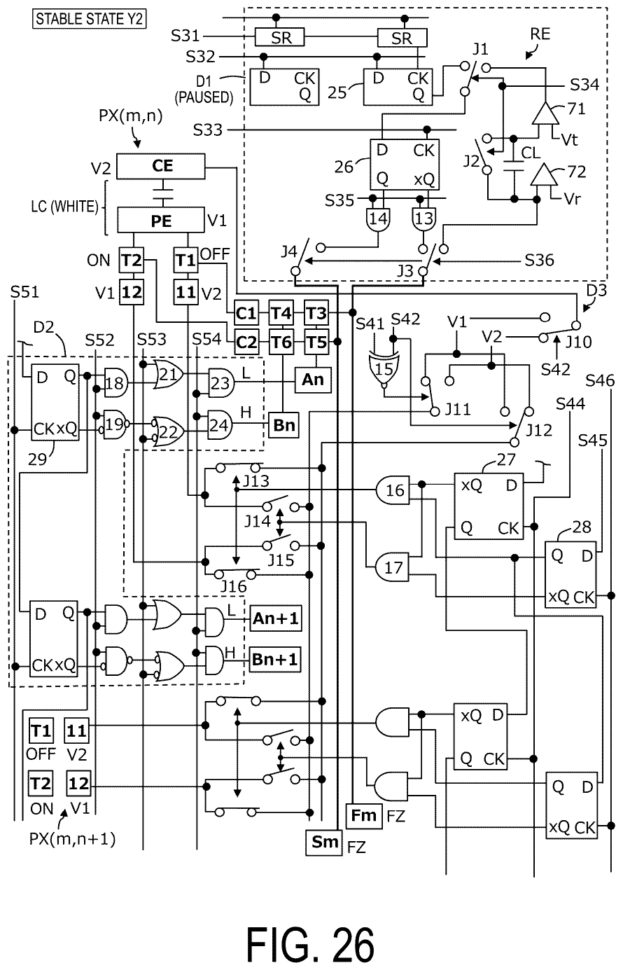

FIG. 26 is a schematic view illustrating a stable state Y2 after the transition state 7. In FIG. 26, the first driver circuit D1 (including the refresh circuit RE) stops and the first and second data lines Fm and Sm are in the floating state FZ (high impedance state). By the second driver circuit D2, the first control line An is set to “L” and the second control line Bn is set to “H” and the fourth and sixth transistors T4 and T6 turn on. By transition from the stable state Y1 to the stable state Y2, threshold-voltage shifts of the third to sixth transistors T3 to T6 can be reduced.

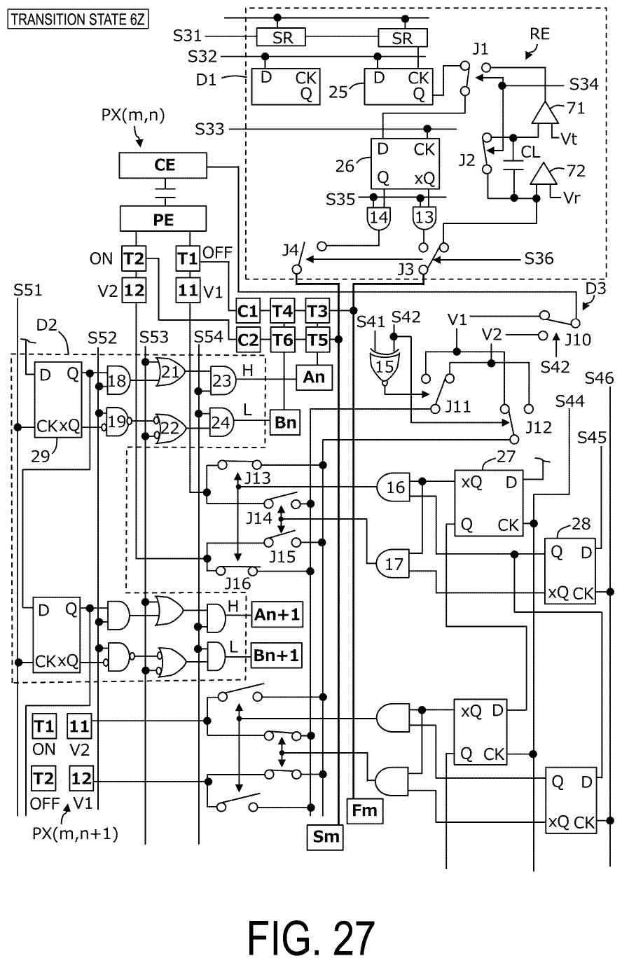

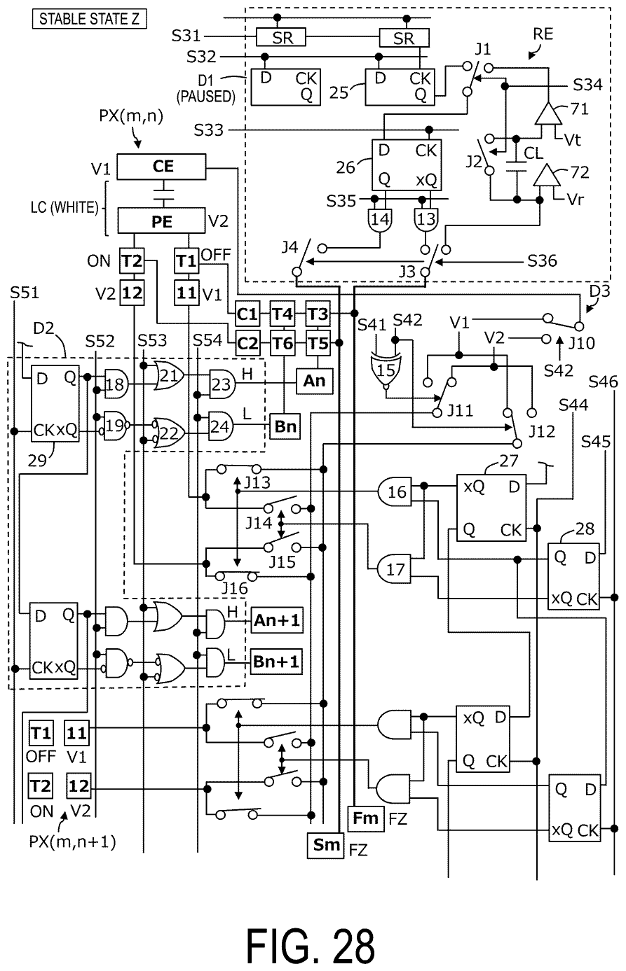

FIG. 27 is a schematic view illustrating a transition state 6Z after the transition state 5 (FIG. 22). FIG. 28 is a schematic view illustrating a stable state Z after the transition state 6Z. In FIGS. 27 and 28, the switch circuit J11 and the switch circuit J12 are connected to the second voltage source (V2 source) and the first voltage source (V1 source), respectively, and the switch circuits J13 and J16 turn on and the switch circuits J14 and J15 turn off, and thus the first power source line 11, the second power source line 12, and the counter electrode CE are set (driven) to V1, V2, and V2, respectively. As a result, a potential of the pixel electrode PE is maintained at V1, and the liquid crystal capacitance LC displays white. By taking the stable state Z, image sticking (caused by application of a DC voltage to the liquid crystal layer) of the liquid crystal layer of the liquid crystal capacitance LC can be avoided and reliability as a display device can be improved.

An interval of transition from the stable state X to the stable state Y1, an interval of transition from the stable state Y1 to the stable state Y2, and an interval of transition from the stable state X to the stable state Z can be individually set in accordance with the characteristics of the first and second memory circuits M1 and M2 (T3 to T6, C1 and C2), the display circuit DS (T1, T2, and LC), and the like.

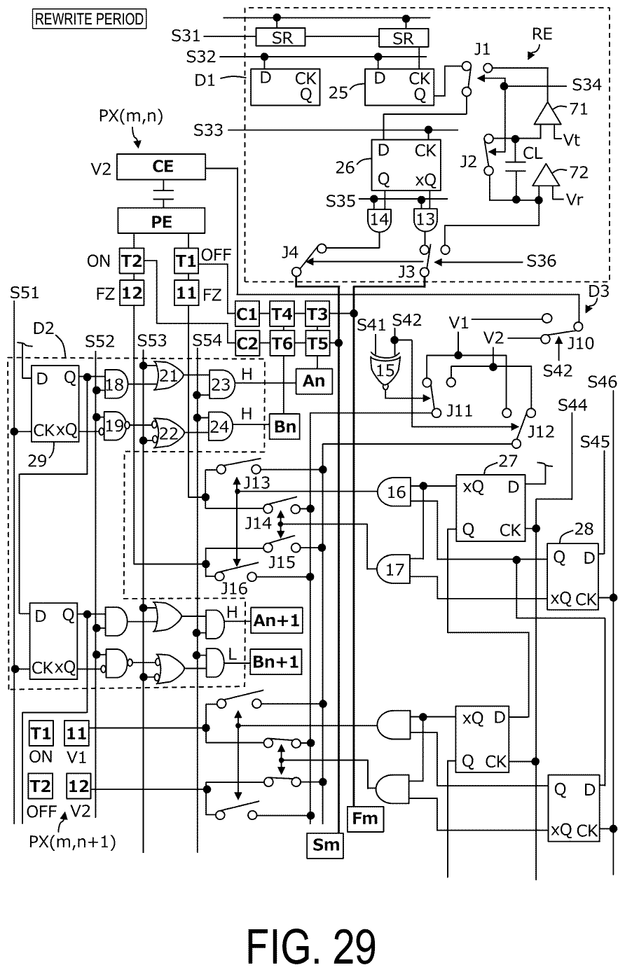

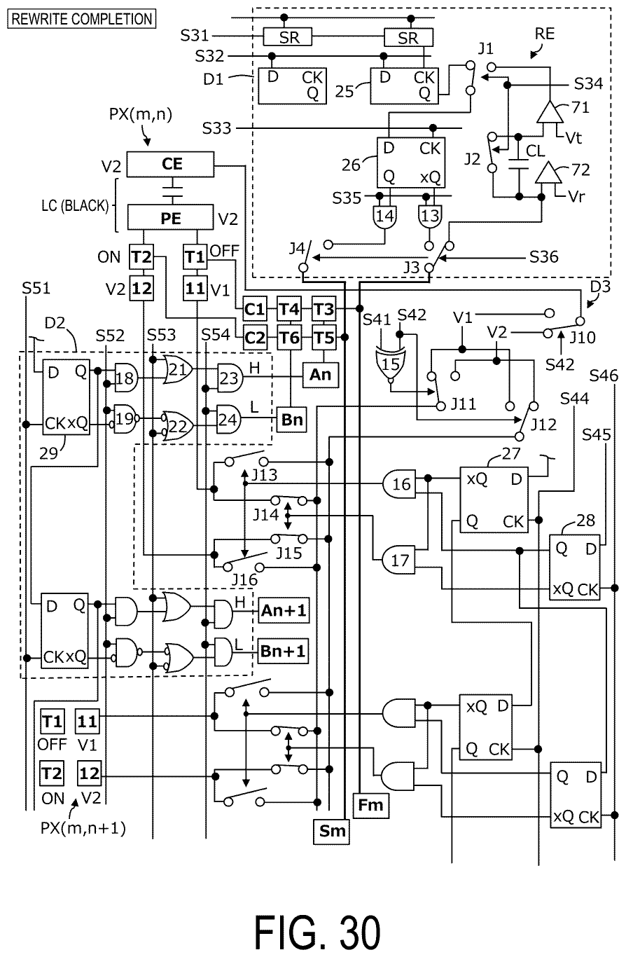

FIG. 29 is a schematic view illustrating a state in a rewrite period. FIG. 30 is a schematic view illustrating a state of rewrite completion. As illustrated in FIGS. 29 and 30, by activating the first driver circuit D1 (including the refresh circuit RE) and setting both the first control line An and the second control line Bn to “High (H)” by the second driver circuit D2, the signal S32 as image data can be written to the first and second memory circuits M1 and M2 via the D flip-flops 25 and 26, the switch circuits J3 and J4, the first and second data lines Fm and Sm, and the third to sixth transistors T3 to T6. That is, “0 (VL)” is written to the first memory circuit M1 and “1 (VH)” is written to the second memory circuit M2, and thus the first transistor T1 turns off and the second transistor T2 turns on.

In FIGS. 29 and 30, the switch circuit J11 and the switch circuit J12 are connected to the first voltage source (V1 source) and the second voltage source (V2 source), respectively and the switch circuits J13 and J16 turn off, and the switch circuits J14 and J15 turn on, and thus the first power source line 11, the second power source line 12, and the counter electrode CE are set (driven) to V1, V2, and V2, respectively. As a result, a potential of the pixel electrode PE is maintained at V2, and the liquid crystal capacitance LC displays black.

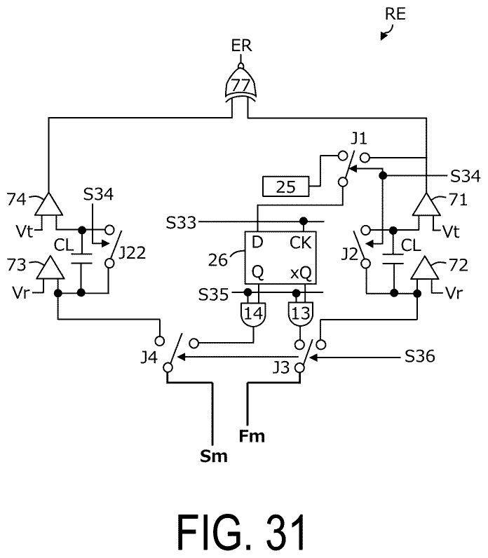

FIG. 31 is a schematic view illustrating a configuration of a refresh circuit. In FIG. 31, the refresh circuit RE is provided with a reading circuit (amplifier circuits 73 and 74, a capacitance element CL, and a switch circuit J22) connected to the switch circuit J4, and an XNOR circuit 77 to which outputs of the amplifier circuits 71 and 74 are input. In this way, the refresh circuit RE can read the memory data of the first and second memory circuits M1 and M2 and notify the timing controller TC (FIG. 1) (notification by an output ER of the XNOR circuit 77) when the memory data are not in the inverted relationship. The timing controller TC having received the notification may write the original data (the most recent rewrite data) to the first and second memory circuits M1 and M2.

The embodiments described above are for the purpose of illustration and description and are not intended to be limiting. It will be apparent to those skilled in the art that many variations will be possible in accordance with these examples and descriptions. The gist of this embodiment will be described below. The term “above-described” as used below includes the configurations disclosed in FIGS. 1 to 30.

A liquid crystal display device including
a pixel including a first memory circuit, a second memory circuit, and a display circuit including a liquid crystal capacitance and connected to the first memory circuit and the second memory circuit,
a first power source line and a second power source line each connected to the display circuit,
a refresh circuit for reading memory data stored in the first memory circuit and writing back the memory data to the first memory circuit in accordance with a result of the reading, and
a control circuit for controlling the refresh circuit.

The above-described liquid crystal display device in which the refresh circuit writes back inverted data of the memory data read from the first memory circuit to the first memory circuit.

The above-described liquid crystal display device in which the refresh circuit writes back the same data as the memory data read from the first memory circuit to the second memory circuit.

The above-described liquid crystal display device in which potentials of the first power source line and the second power source line are exchanged to each other in accordance with the writing-back.

The above-described liquid crystal display device in which the refresh circuit receives an instruction from the control circuit and performs the writing-back within a memory maintaining period of the first memory circuit.

The above-described liquid crystal display device in which the control circuit includes a timer and a timing controller, and the timing controller activated by the timer controls the refresh circuit.

The above-described liquid crystal display device in which the refresh circuit stops after the writing-back.

The above-described liquid crystal display device in which the timing controller stops after the writing-back.

The above-described liquid crystal display device in which the refresh circuit includes a reading circuit for reading memory data and a latch circuit for latching the read memory data.

The above-described liquid crystal display device includes a first data line connected to the first memory circuit and a second data line connected to the second memory circuit, in which
the display circuit includes a first transistor connected to the first memory circuit and a second transistor connected to the second memory circuit,
the liquid crystal capacitance includes a pixel electrode, and a counter electrode, and
the pixel electrode is connected to the first power source line via the first transistor and is connected to the second power source line via the second transistor.

The above-described liquid crystal display device includes a refresh period in which the reading and the writing-back are performed and a hold period in which the memory data of each of the first memory circuit and the second memory circuit are maintained.

The above-described liquid crystal display device includes a first control line for controlling the first memory circuit and a second control line for controlling the second memory circuit, in which
drive signals output to the first and second control lines are inverted during the hold period.

The above-described liquid crystal display device in which a potential supplied to the counter electrode is exchanged in accordance with the writing-back.

The above-described liquid crystal display device in which the refresh circuit latches memory data read from the first memory circuit and outputs inverted data of the latched memory data to the first memory circuit in the refresh period.

The above-described liquid crystal display device includes a first driver circuit including the refresh circuit and driving the first data line and the second data line.

The above-described liquid crystal display device in which the first driver circuit stops during the hold period.

The above-described liquid crystal display device includes a second driver circuit for driving the first control line and the second control line, and
a third driver circuit for driving the first power source line and the second power source line.

The above-described liquid crystal display device which the third driver circuit drives the counter electrode.

The above-described liquid crystal display device includes a rewrite period for rewriting memory data of each of the first memory circuit and the second memory circuit.

The above-described liquid crystal display device in which the refresh circuit reads memory data stored in the second memory circuit, and
notifies the timing controller when the memory data stored in the first memory circuit and the memory data stored in the second memory circuit are not in an inverted relationship.

The above-described liquid crystal display device in which the timing controller having received the notification writes original data in the first and second memory circuits.

The above-described liquid crystal display device in which
the first memory circuit includes a first capacitance, a third transistor, and a fourth transistor,
the second memory circuit includes a second capacitance, a fifth transistor, and a sixth transistor,
gate terminals of the third and fifth transistors are connected to the first control line,
gate terminals of the fourth and sixth transistors are connected to the second control line,
the first data line is connected to a gate terminal of the first transistor via the third and fourth transistors,
the second data line is connected to a gate terminal of the second transistor via the fifth and sixth transistors,
the gate terminal of the first transistor is connected to the first capacitance, and
the gate terminal of the second transistor is connected to the second capacitance.

The above-described liquid crystal display device includes a display region in which a pixel group including the pixel is provided, and a non-display region in which the refresh circuit is provided.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device comprising:
a pixel including a first memory circuit, a second memory circuit, and a display circuit including a liquid crystal capacitance and connected to the first memory circuit and the second memory circuit;
a first power source line and a second power source line each connected to the display circuit;
a refresh circuit configured to read memory data stored in the first memory circuit and write back the memory data to the first memory circuit in accordance with a result of the reading; and
a control circuit configured to control the refresh circuit.

2. The liquid crystal display device according to claim 1,
wherein the refresh circuit writes back inverted data of the memory data read from the first memory circuit to the first memory circuit.

3. The liquid crystal display device according to claim 2,
wherein the refresh circuit writes back the same data as the memory data read from the first memory circuit to the second memory circuit.

4. The liquid crystal display device according to claim 1,
wherein potentials of the first power source line and the second power source line are exchanged to each other in accordance with the writing-back.

5. The liquid crystal display device according to claim 1,
wherein the refresh circuit receives an instruction from the control circuit and performs the writing-back within a memory maintaining period of the first memory circuit.

6. The liquid crystal display device according to claim 1,
wherein the control circuit includes a timer and a timing controller, and
the timing controller activated by the timer controls the refresh circuit.

7. The liquid crystal display device according to claim 1,
wherein the refresh circuit stops after the writing-back.

8. The liquid crystal display device according to claim 6,
wherein the timing controller stops after the writing-back.

9. The liquid crystal display device according to claim 1,
wherein the refresh circuit includes a reading circuit configured to read memory data and
a latch circuit configured to latch the read memory data.

10. The liquid crystal display device according to claim 1, further comprising:
a first data line connected to the first memory circuit; and
a second data line connected to the second memory circuit,
wherein the display circuit includes a first transistor connected to the first memory circuit and a second transistor connected to the second memory circuit,
the liquid crystal capacitance includes a pixel electrode and a counter electrode, and
the pixel electrode is connected to the first power source line via the first transistor and is connected to the second power source line via the second transistor.

11. The liquid crystal display device according to claim 10, further comprising:
a refresh period in which the reading and the writing-back are performed; and
a hold period in which the memory data of each of the first memory circuit and the second memory circuit are maintained.

12. The liquid crystal display device according to claim 11, further comprising:
a first control line configured to control the first memory circuit; and
a second control line configured to control the second memory circuit,
wherein drive signals output to the first and second control lines are inverted during the hold period.

13. The liquid crystal display device according to claim 10,
wherein a potential supplied to the counter electrode is exchanged in accordance with the writing-back.

14. The liquid crystal display device according to claim 11,
wherein the refresh circuit latches memory data read from the first memory circuit and outputs inverted data of the latched memory data to the first memory circuit in the refresh period.

15. The liquid crystal display device according to claim 11, further comprising:
a first driver circuit including the refresh circuit and configured to drive the first data line and the second data line.

16. The liquid crystal display device according to claim 15,
wherein the first driver circuit stops during the hold period.

17. The liquid crystal display device according to claim 12, further comprising:
a second driver circuit configured to drive the first control line and the second control line; and
a third driver circuit configured to drive the first power source line and the second power source line.

18. The liquid crystal display device according to claim 17,
wherein the third driver circuit drives the counter electrode.

19. The liquid crystal display device according to claim 12, further comprising:
a rewrite period configured to rewrite memory data of each of the first memory circuit and the second memory circuit.

20. The liquid crystal display device according to claim 6,
wherein the refresh circuit reads memory data stored in the second memory circuit, and
notifies the timing controller when the memory data stored in the first memory circuit and the memory data stored in the second memory circuit are not in an inverted relationship.

21. The liquid crystal display device according to claim 19,
wherein the timing controller having received the notification writes original data in the first and second memory circuits.

22. The liquid crystal display device according to claim 10,
wherein the first memory circuit includes a first capacitance, a third transistor, and a fourth transistor,
the second memory circuit includes a second capacitance, a fifth transistor, and a sixth transistor,
gate terminals of the third and fifth transistors are connected to the first control line,
gate terminals of the fourth and sixth transistors are connected to the second control line,
the first data line is connected to a gate terminal of the first transistor via the third and fourth transistors,
the second data line is connected to a gate terminal of the second transistor via the fifth and sixth transistors,
the gate terminal of the first transistor is connected to the first capacitance, and
the gate terminal of the second transistor is connected to the second capacitance.

23. The liquid crystal display device according to claim 1, further comprising:
a display region in which a pixel group including the pixel is provided; and
a non-display region in which the refresh circuit is provided.
